(19) United States
(12) Patent Application Publication
(10) Pub. No.: US 2019/0224893 A1
(43) Pub. Date: Jul. 25, 2019

(54) INJECTION MOLDING MACHINE AND INJECTION MOLDING METHOD

(71) Applicant: FANUC CORPORATION, Yamanashi (JP)

(72) Inventor: Hajime OONO, Yamanashi (JP)

(73) Assignee: FANUC CORPORATION, Yamanashi (JP)

(21) Appl. No.: 16/224,606

(22) Filed: Dec. 18, 2018

(30) Foreign Application Priority Data
Jan. 19, 2018 (JP) 2018-007631

(51) Int. Cl. B29C 45/04; B29C 45/40; B29C 45/26

(52) U.S. Cl. CPC B29C 45/0408; B29C 45/26; B29C 45/40

(57) ABSTRACT

The injection molding machine includes a first mold connector, a second mold connector, a mold moving device, a mold movement control unit that controls the mold moving device, and a mold connection control unit that controls the first mold connector and the second mold connector so that in a first mold opening state, the first mold connector disconnects a fixed mold and an intermediate mold and the second mold connector connects the movable mold and the intermediate mold, and in a second mold opening state, the first mold connector connects the fixed mold and the intermediate mold and the second mold connector disconnects the movable mold and the intermediate mold.

This application is based on and claims the benefit of priority from Japanese Patent Application No. 2018-007631, filed on 19 Jan. 2018, the content of which is incorporated herein by reference.

### BACKGROUND OF THE INVENTION

### Field of the Invention

The present invention relates to an injection molding machine and an injection molding method executed by the injection molding machine.

### Related Art

Conventionally, a three-plate-type mold (hereinafter also referred to as a “three-plate mold”) including a fixed mold, a movable mold, and an intermediate mold is known as a mold used in an injection molding machine. When the three-plate mold is open, a space is formed between the fixed mold and the intermediate mold and between the movable mold and the intermediate mold. Therefore, simultaneously with opening of the mold after molding, it is possible to separate a molded product from a runner and separate the runner from a gate.

Patent Document 1: Japanese Unexamined Patent Application, Publication No. 2013-49229

### SUMMARY OF THE INVENTION

The molded product and the runner are taken out from the three-plate mold at a position at which the intermediate mold is inserted so that the fixed mold and the movable mold are separated from each other. Therefore, in an injection molding machine, a mold having such a mold opening amount that both the molded product and the runner (hereinafter also referred to as “molded product and the like”) after molding can be taken out is used. Generally, since a mold included in a large injection molding machine has a large mold opening amount, although it is easy to take out the molded product and the like, the cost of the machine increases. On the other hand, since a mold included in a small injection molding machine has a small mold opening amount, although it is difficult to take out the molded product and the like, it is possible to reduce the cost of the machine. Therefore, in molding using a three-plate mold, it is requested to facilitate taking out of a molded product and the like and to further reduce the size of an injection molding machine.

An object of the present invention is to provide an injection molding machine and an injection molding method capable of easily taking out a molded product and the like and further reducing the size of a mold when performing molding using a three-plate mold.

(1) The present invention provides an injection molding machine (for example, an injection molding machine 1 to be described later) including a three-plate-type mold (for example, a mold 10 to be described later) including a fixed mold (for example, a fixed mold 11 to be described later), a movable mold (for example, a movable mold 12 to be described later) that is movable in relation to the fixed mold, and an intermediate mold (for example, an intermediate mold 13 to be described later) provided between the fixed mold and the movable mold, the injection molding machine filling a molding material in a cavity formed by closing the fixed mold, the movable mold, and the intermediate mold to mold a molded product, the injection molding machine including: a first mold connector (for example, a first mold connector 40, 140, 240 to be described later) that connects or disconnects the fixed mold and the intermediate mold to or from each other; a second mold connector (for example, a second mold connector 50, 150, 250 to be described later) that connects or disconnects the movable mold and the intermediate mold to or from each other; a mold moving device (for example, a mold moving device 20 to be described later) that moves the movable mold in relation to the fixed mold; a mold movement control unit (for example, a mold movement control unit 61 to be described later) that controls the mold moving device so that any one of a mold closing state in which the movable mold, the intermediate mold, and the fixed mold are connected, a first mold opening state in which the movable mold is separated from the fixed mold together with the intermediate mold, and a second mold opening state in which the movable mold is separated from the intermediate mold and the fixed mold is created; and a mold connection control unit (for example, a mold connection control unit 62 to be described later) that controls the first mold connector and the second mold connector so that in the first mold opening state, the first mold connector disconnects the fixed mold and the intermediate mold and the second mold connector connects the movable mold and the intermediate mold, and in the second mold opening state, the first mold connector connects the fixed mold and the intermediate mold and the second mold connector disconnects the movable mold and the intermediate mold.

(2) In the injection molding machine according to (1), the first mold connector (for example, a first mold connector 40, 140 to be described later) and the second mold connector (for example, a second mold connector 50, 150 to be described later) each may include: a movable pin (for example, a movable pin 42, 52, 142, 152 to be described later) provided in one mold; a fixing pin (for example, a fixing pin 43, a supporting pin 53, a fixing pin 143, 153 to be described later) provided in the other mold; and a lock bar (for example, a lock bar 41, 51, 141, 151 to be described later) having a supporting portion (for example, a supporting portion 45, 55, 145, 155 to be described later) fixed to the fixing pin and a pin engagement portion (for example, a pin engagement portion 44, 54, 144, 154 to be described later) configured to engage with the movable pin, and the movable pin moves to a position at which the movable pin engages with the pin engagement portion of the lock bar so that both molds enter into a connection state, and the movable pin moves to a position at which the movable pin is disengaged from the pin engagement portion of the lock bar so that both molds enter into a disconnection state.

(3) In the injection molding machine according to (1), the first mold connector (for example, a first mold connector 240 to be described later) and the second mold connector (for example, a second mold connector 250 to be described later) each may include: a movable pin (for example, a movable pin 242, 252 to be described later) provided in one mold; a fixing pin (for example, a fixing pin 243, 253 to be described later) provided in the other mold; and a lock bar (for example, a lock bar 241, 251 to be described later) having a supporting portion (for example, a supporting portion 245, 255 to be described later) fixed to the movable pin and a pin engagement portion (for example, a pin engagement portion 244, 254 to be described later) configured to engage with the fixing pin, and the movable pin rotates and the pin engagement portion of the lock bar engages with the fixing pin so that both molds enter into a connection state, and the movable pin rotates in an opposite direction and the pin engagement portion of the lock bar is disengaged from the fixing pin so that both molds enter into a disconnection state.

(4) The present invention also provides an injection molding method executed by an injection molding machine including: a three-plate-type mold including a fixed mold, a movable mold that is movable in relation to the fixed mold, and an intermediate mold provided between the fixed mold and the movable mold; a first mold connector that connects or disconnects the fixed mold and the intermediate mold to or from each other; a second mold connector that connects or disconnects the movable mold and the intermediate mold to or from each other; and a mold moving device that moves the movable mold in relation to the fixed mold, wherein a first mold opening state in which the movable mold is separated from the fixed mold together with the intermediate mold, the first mold connector disconnects the fixed mold and the intermediate mold and the second mold connector connects the movable mold and the intermediate mold, and a second mold opening state in which the movable mold is separated from the intermediate mold and the fixed mold, the first mold connector connects the fixed mold and the intermediate mold and the second mold connector disconnects the movable mold and the intermediate mold.

According to the present invention, it is possible to provide an injection molding machine and an injection molding method capable of easily taking out a molded product and the like and further reducing the size of a mold when performing molding using a three-plate mold.

### BRIEF DESCRIPTION OF THE DRAWINGS

FIG. 1 is a conceptual diagram illustrating an entire configuration of an injection molding machine 1 according to a first embodiment.

FIG. 2 is a block diagram illustrating a functional configuration of the injection molding machine 1.

FIG. 3A is a schematic diagram illustrating an inner structure when a mold 10 and a fixed-side attachment plate 14 are in a mold opening state.

FIG. 3B is a schematic diagram illustrating an inner structure when the mold 10 and the fixed-side attachment plate 14 are in a mold closing state.

FIG. 4A is a schematic diagram illustrating a state in which a first mold connector 40 and a second mold connector 50 are connected.

FIG. 4B is a schematic diagram illustrating a state in which the first mold connector 40 is disconnected.

FIG. 5A is a schematic diagram illustrating a closed mold 10.

FIG. 5B is a schematic diagram illustrating an injection step.

FIG. 5C is a schematic diagram illustrating a first mold opening step.

FIG. 5D is a schematic diagram illustrating a first mold opening step.

FIG. 5E is a schematic diagram illustrating a runner take-out step.

FIG. 5F is a schematic diagram illustrating a mold closing step.

FIG. 5G is a schematic diagram illustrating a second mold opening step and a molded product take-out step.

FIG. 6 is a flowchart illustrating a processing procedure of a mold moving and connecting control program executed by a controller 60 of the first embodiment.

FIG. 7A is a schematic diagram illustrating a state in which a first mold connector 140 and a second mold connector 150 according to a second embodiment are connected.

FIG. 7B is a cross-sectional view along line A-A in FIG. 7A.

FIG. 7C is a cross-sectional view along line A-A in FIG. 7A.

FIG. 7D is a schematic diagram illustrating a state in which the first mold connector 140 of the second embodiment is disconnected.

FIG. 8A is a schematic diagram illustrating a state in which a first mold connector 240 and a second mold connector 250 according to a third embodiment are connected.

FIG. 8B is a schematic diagram illustrating a state in which the first mold connector 240 and the second mold connector 250 according to the third embodiment are disconnected.

### DETAILED DESCRIPTION OF THE INVENTION

Hereinafter, embodiments of the present invention will be described. The drawings attached to the present specification are conceptual diagrams or schematic diagrams, and shapes, scales, dimensional ratios, and the like of respective portions are changed or exaggerated from the actual ones for better understanding of the invention.

### First Embodiment

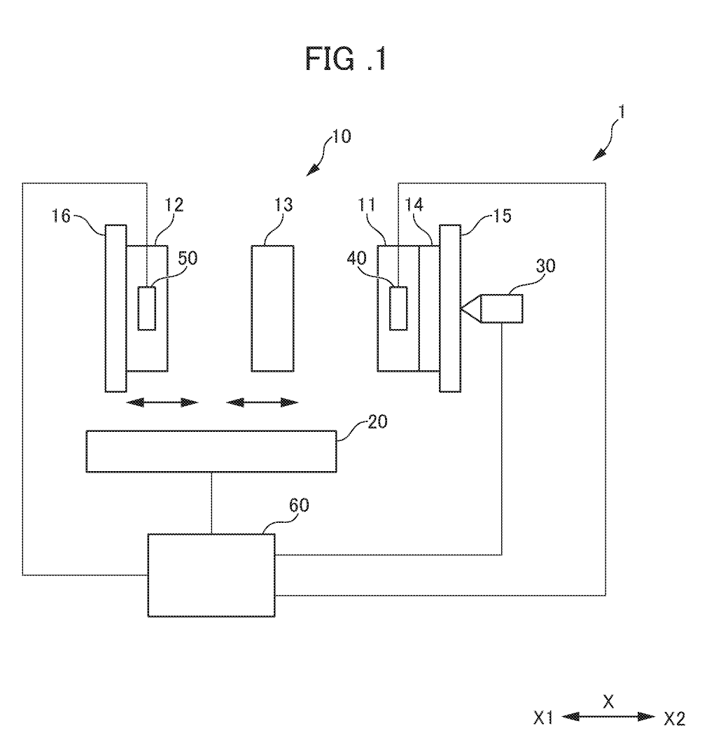

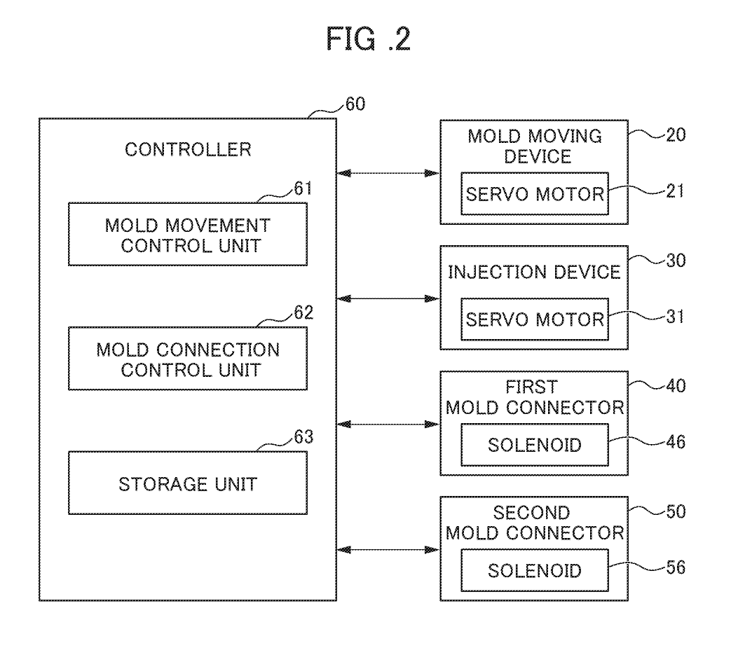

FIG. 1 is a schematic diagram illustrating an entire configuration of an injection molding machine 1 according to a first embodiment. FIG. 2 is a block diagram illustrating a functional configuration of the injection molding machine 1. A basic configuration of the injection molding machine 1 according to the first embodiment is common to second and third embodiments to be described later.

In the present specification and the like, a moving direction of a movable mold 12 to be described later in the layout illustrated in FIG. 1 is defined as an X (X1-X2) direction and will be described using arrows in the drawings.

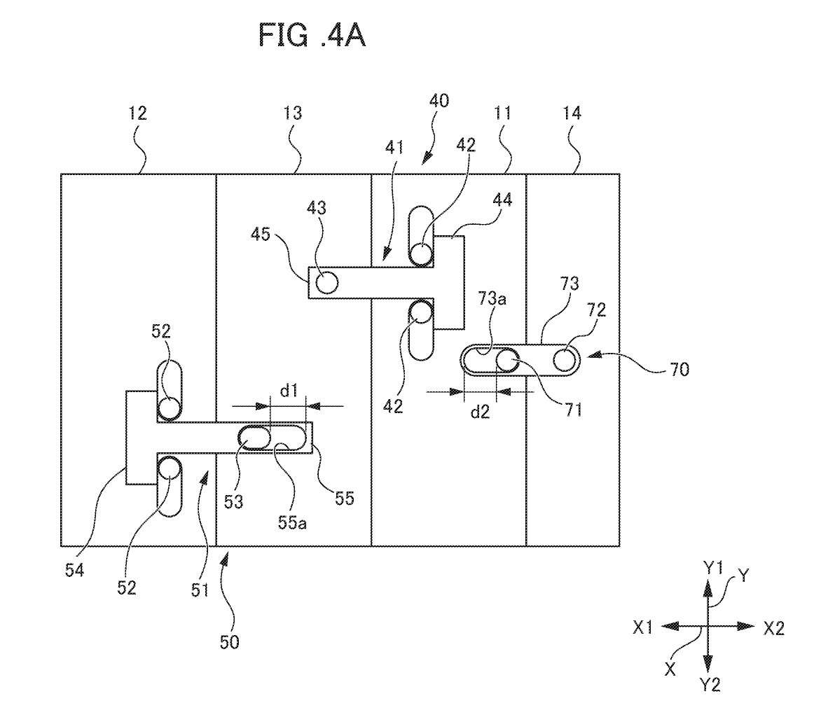

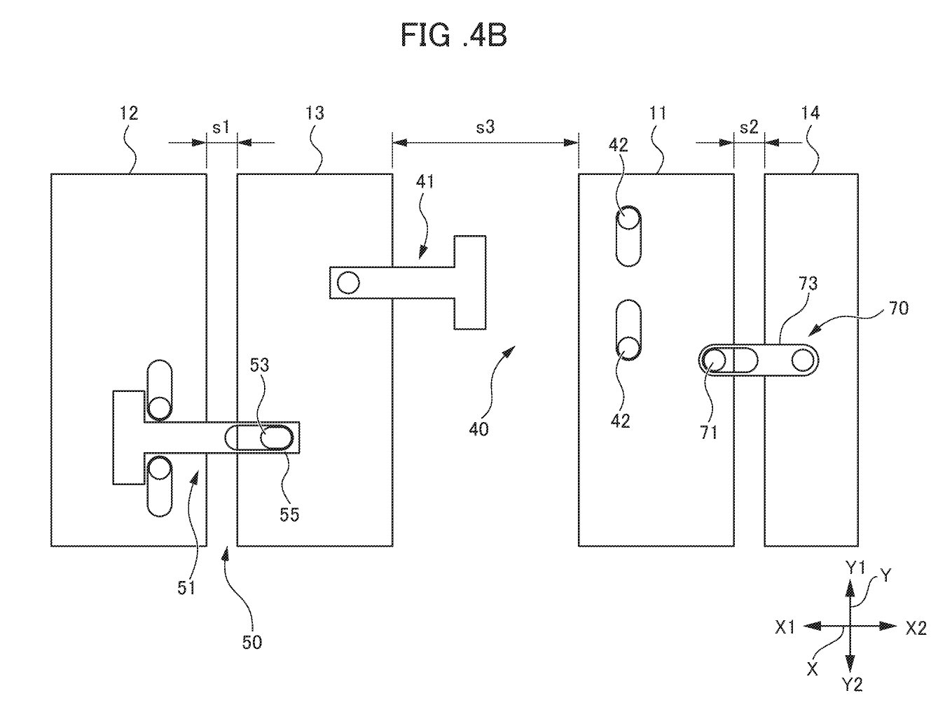

In the X-direction, a direction in which the movable mold 12 separated from a fixed mold 11 is defined as an X1-direction, and a direction in which the movable mold 12 approaches the fixed mold 11 is defined as an X2-direction. On the drawing sheet, a direction orthogonal to the X-direction is defined as a Y (Y1-Y2) direction. In the Y-direction, arrows are used in a drawing (for example, FIG. 4A) where the description of this direction is necessary.

As illustrated in FIG. 1, the injection molding machine 1 includes a mold 10, a mold moving device 20, an injection device 30, a first mold connector 40, a second mold connector 50, and a controller 60. The mold 10 includes a fixed mold 11, a movable mold 12, and an intermediate mold 13. The mold 10 of the first embodiment is configured as a three-plate-type mold including the fixed mold 11, the movable mold 12, and the intermediate mold 13.

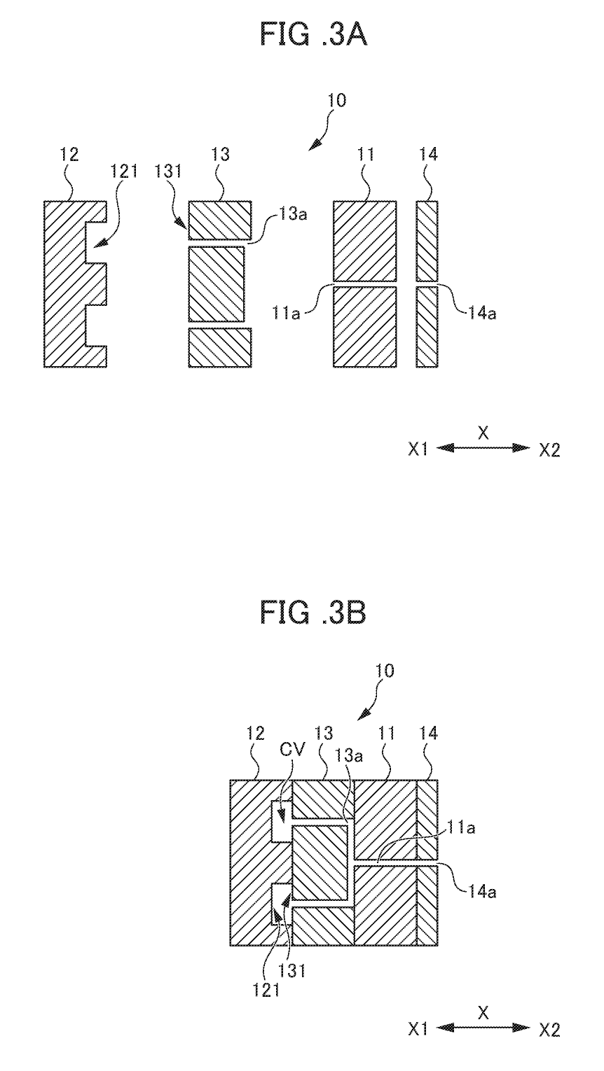

The fixed mold 11 is a mold provided on the X2 side of the mold 10 and is supported by a fixed-side attachment plate 14. The fixed mold 11 includes a channel 11a(see FIG. 3A) serving as a passage of a molding material. The fixed-side attachment plate 14 is a planar member that supports the fixed mold 11, and a surface on the opposite side of the fixed mold 11 is attached to a fixed-side platen 15. The fixed-side platen 15 is a planar member that supports the fixed-side attachment plate 14 to thereby support the fixed mold 11. The fixed mold 11 includes a first mold connector 40 (to be described later).

As will be described later, a portion of the first mold connector 40 is provided in the intermediate mold 13. The fixed mold 11 moves together with the intermediate mold 13 so that a very small gap (s2) is formed in the X-direction in the course in which first and second mold closing and opening states to be described later are created.

The movable mold 12 is a mold having a molding surface 121 (see FIG. 3A) on a side facing the intermediate mold 13 and is configured to be movable in the X (X1-X2) direction with the driving force of the mold moving device 20. In the movable mold 12, an ejector (not illustrated) is provided on a side (the X1 side) opposite the molding surface 121. The ejector is a device that ejects a molded product molded by the mold 10 from the movable mold 12. The ejector ejects a molded product from the molding surface 121 of the movable mold 12 in such a way that an ejector pin (not illustrated) protrude from an X1-side surface of the movable mold 12 toward an X2-side molding surface, for example. The movable mold 12 includes the second mold connector 50 (to be described later). As will be described later, a portion of the second mold connector 50 is provided in the intermediate mold 13.

The intermediate mold 13 is a mold having a molding surface 131 (see FIG. 3A) on a surface facing the movable mold 12, and is provided between the fixed mold 11 and the movable mold 12. The intermediate mold 13 is configured to be movable in the X (X1-X2) direction. The intermediate mold 13 is a mold that does not move independently but moves by being pressed by the movable mold 12 to be described later or being pulled in a connected state.

When the fixed mold 11, the movable mold 12, and the intermediate mold 13 are closed, a cavity CV (see FIG. 3B) formed by the molding surface 121 of the movable mold 12 and the molding surface 131 of the intermediate mold 13 is formed inside the mold 10. A molded product is molded by filling a molding material in the cavity CV from the injection device 30.

The mold moving device 20 is a device that moves the movable mold 12 in the X (X1-X2) direction in relation to the fixed mold 11. The mold moving device 20 includes a servo motor 21 (see FIG. 2) of which the rotation direction and the rotation amount are controlled by the controller 60. The servo motor 21 is driven by a mold closing start signal transmitted from a mold movement control unit 61 (the controller 60) to be described later to move the movable mold 12 in the direction (X2 direction) closer to the fixed mold 11. Moreover, the servo motor 21 is driven by a mold opening start signal transmitted from the mold movement control unit 61 (the controller 60) to move the movable mold 12 in the direction (X1 direction) away from the fixed mold 11. The movable mold 12 moves independently, and as will be described later, moves while pressing the intermediate mold 13 in the X2 direction and moves in the X1 direction while pulling the intermediate mold 13 connected thereto.

The injection device 30 is a device that fills a molding material (for example, plastics or the like) in the closed mold 10. The injection device 30 has a nozzle at a distal end thereof being connected to a sprue hole (not illustrated) formed in the fixed-side platen 15. The injection device 30 includes a servo motor 31 (see FIG. 2) of which the rotation direction and the rotation amount are controlled by the controller 60. The servo motor 31 is driven by an injection control signal transmitted from the controller 60 to rotate a screw mechanism provided in a cylinder of the injection device 30 to thereby fill a predetermined amount of molding material in the mold 10.

The first mold connector 40 is a device that connects or disconnects the fixed mold 11 and the intermediate mold 13. The first mold connector 40 includes a solenoid 46 (see FIG. 2) as a power source when switching a connection state. The solenoid 46 is driven by a connection signal or a disconnection signal transmitted from a mold connection control unit 62 (the controller 60) to be described later to connect or disconnect the fixed mold 11 and the intermediate mold 13 to or from each other.

The second mold connector 50 is a device that connects or disconnects the movable mold 12 and the intermediate mold 13 to or from each other. The second mold connector 50 includes a solenoid 56 (see FIG. 2) as a power source when switching a connection state. The solenoid 56 is driven by a connection signal or a disconnection signal transmitted from the mold connection control unit 62 (the controller 60) to be described later to connect or disconnect the movable mold 12 and the intermediate mold 13 to or from each other. A specific example of the first mold connector 40 and the second mold connector 50 will be described later.

The controller 60 is a device that is electrically connected to the mold moving device 20, the ejector (not illustrated), the injection device 30, and the like of the injection molding machine 1 to control the operations of these respective devices. Specifically, the controller 60 controls an operation of the mold moving device 20 closing and opening the mold 10, an operation of the ejector ejecting a molded product, an operation of the injection device 30 injecting a molding material, and the like. The controller 60 executes these basic operations of the injection molding machine 1 as control of a controller main body. Hereinafter, a portion of the controller 60 controlling a basic operation of the injection molding machine 1 will be appropriately referred to as a “controller main body”.

The controller 60 is configured as a micro-processor unit including a central processing unit (CPU), a memory, and the like. The controller 60 realizes various functions in cooperation with respective hardware components by reading an application program (for example, a mold moving and connecting control program to be described later) for controlling the injection molding machine 1 from a storage unit 63 and executing the program.

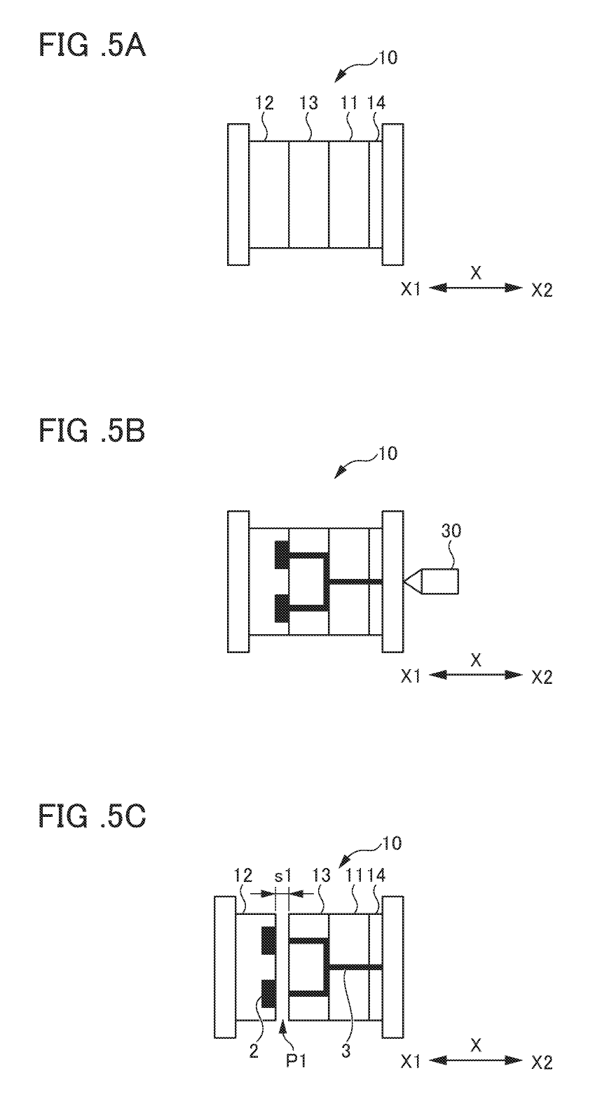

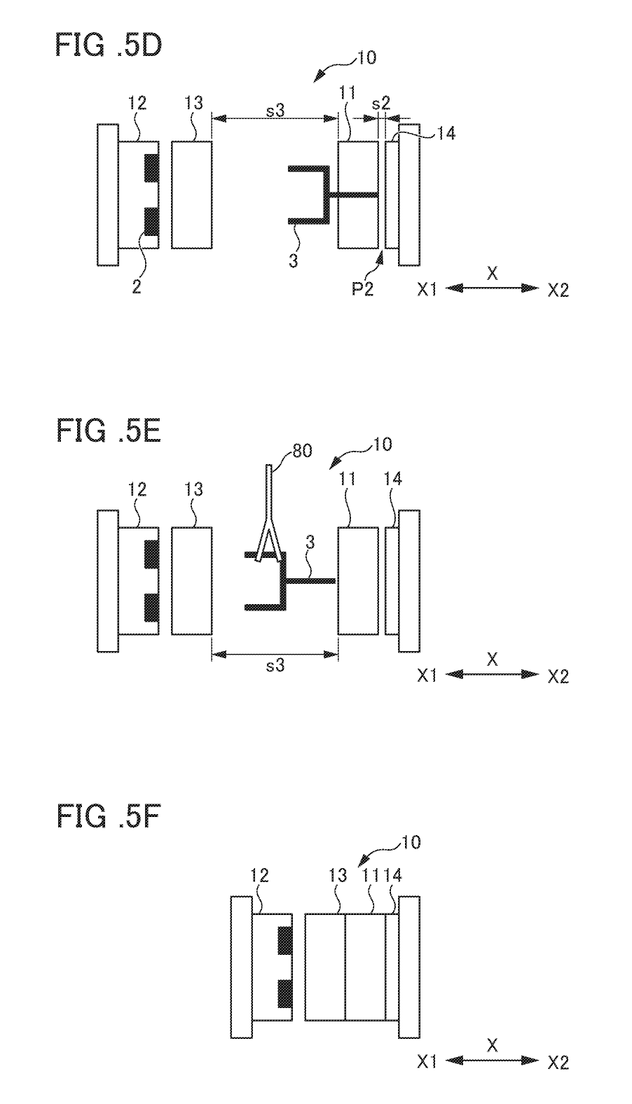

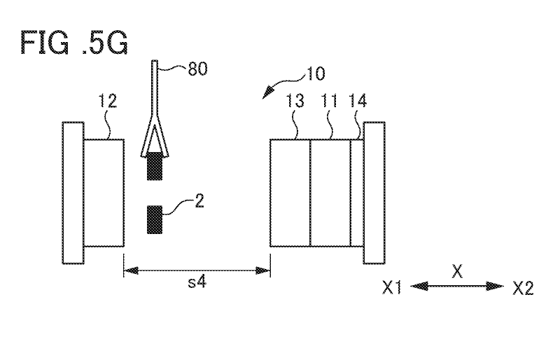

As illustrated in FIG. 2 the controller 60 includes the mold movement control unit 61, the mold connection control unit 62, and the storage unit 63. The mold movement control unit 61 moves the movable mold 12 so that any one of a mold closing state (for example, see FIG. 5A to be described later) in which the fixed mold 11, the movable mold 12, and the intermediate mold 13 of the mold 10 are connected together, a first mold opening state (for example, see FIG. 5D to be described later) in which the movable mold 12 and the intermediate mold 13 are separated from the fixed mold 11, and a second mold opening state (for example, see FIG. 5G to be described later) in which the movable mold 12 is separated from the intermediate mold 13 and the fixed mold 11 is created.

A specific example of the mold closing state, the first mold opening state, and the second mold opening state will be described later.

In the mold closing state, the mold connection control unit 62 controls the first mold connector 40 and the second mold connector 50 so that the first mold connector 40 connects the fixed mold 11 and the intermediate mold 13 and the second mold connector 50 connects the movable mold 12 and the intermediate mold 13. In the first mold opening state, the mold connection control unit 62 controls the first mold connector 40 and the second mold connector 50 so that the first mold connector 40 disconnects the fixed mold 11 from the intermediate mold 13 and the second mold connector 50 connects the movable mold 12 and the intermediate mold 13. In the second mold opening state, the mold connection control unit 62 controls the first mold connector 40 and the second mold connector 50 so that the first mold connector 40 connects the fixed mold 11 and the intermediate mold 13 and the second mold connector 50 disconnects the movable mold 12 from the intermediate mold 13.

The mold connection control unit 62 controls a connection state of each connector by transmitting a connection signal or a disconnection signal to the first mold connector 40 and the second mold connector 50. The operations of the first mold connector 40 and the second mold connector 50 controlled by the mold connection control unit 62 will be described later.

The storage unit 63 is a storage device in which various programs executed by the injection molding machine 1, data, and the like are stored. The storage unit 63 is configured as a semiconductor memory, a hard disk device, and the like, for example. A mold moving and connecting control program, for example, is stored in the storage unit 63 as an application program.

Next, an inner structure of the mold 10 and the fixed-side attachment plate 14 will be described. FIG. 3AB are schematic diagrams illustrating an inner structure of the mold 10 and the fixed-side attachment plate 14. FIG. 3A is a schematic diagram illustrating an inner structure when the mold 10 and the fixed-side attachment plate 14 are in a mold opening state. FIG. 3B is a schematic diagram illustrating an inner structure when the mold 10 and the fixed-side attachment plate 14 are in a mold closing state. The mold opening state illustrated in FIG. 3A illustrate a state in which respective molds are separated from each other for better understanding of the structures of the respective portions, and is different from a first mold opening state and a second mold opening state to be described later.

As illustrated in FIG. 3A, the fixed mold 11 has a channel 11a for a molding material provided therein. Moreover, the fixed-side attachment plate 14 has a channel 14a for a molding material provided therein. These channels 11a and 14a communicate with each other when the mold 10 is in a mold closing state. Although not illustrated in the drawing, the fixed-side platen 15 (see FIG. 1) has a sprue hole formed at a position facing the channel 14a of the fixed-side attachment plate 14. A nozzle at the distal end of the injection device 30 is connected to the sprue hole.

As illustrated in FIG. 3A, the movable mold 12 has a molding surface 121 on a side facing the intermediate mold 13.

As illustrated in FIG. 3A, the intermediate mold 13 has a molding surface 131 on a side facing the movable mold 12. The intermediate mold 13 has a channel 13a for a molding material. The channel 13a communicates with the molding surface 131.

When the mold 10 illustrated in FIG. 3A is in a mold closing state together with the fixed-side attachment plate 14, as illustrated in FIG. 3B, a cavity CV formed by the molding surface 121 of the movable mold 12 and the molding surface 131 of the intermediate mold 13 is formed inside the mold 10. The cavity CV communicates with the channel 13a (the intermediate mold 13), the channel 11a (the fixed mold 11), and the channel 14a (the fixed-side attachment plate 14). Therefore, a molding material delivered from the sprue hole (not illustrated) of the fixed-side platen 15 by the injection device 30 passes through the respective channels and is filled in the cavity CV. In the mold 10 after molding, a molded product remains in the cavity CV, and a runner remains in the respective channels and the sprue hole. The molded product and the runner are integrated in the fixed-side attachment plate 14 and the mold 10 after molding. As will be described later, the molded product and the runner are separated when the mold 10 is open.

Next, a configuration of the first mold connector 40 and the second mold connector 50 will be described. FIGS. 4A and 4B are schematic diagrams illustrating the first mold connector 40 and the second mold connector 50. FIG. 4A is a schematic diagram illustrating a state in which the first mold connector 40 and the second mold connector 50 are connected.

FIG. 4B is a schematic diagram illustrating a state in which the first mold connector 40 is disconnected.

As illustrated in FIG. 4A, the first mold connector 40 includes a lock bar 41, a movable pin 42, and a fixing pin 43.

The lock bar 41 is a member that connects or disconnects the fixed mold 11 and the intermediate mold 13 to or from each other. The lock bar 41 includes a pin engagement portion 44 and a supporting portion 45. The pin engagement portion 44 is a portion formed in an approximately T-form. The movable pin 42 engages with the pin engagement portion 44. The supporting portion 45 is a portion fixed to the fixing pin 43.

The movable pin 42 is a member movable in the Y (Y1-Y2) direction. Two movable pins 42 are formed in the fixed mold 11 along the Y-direction. FIG. 4A illustrates a state in which the movable pin 42 is moved to a position (hereinafter also referred to as a “connection position”) at which the movable pin 42 is connected to the lock bar 41. When the movable pin 42 is moved to the connection position, since the movable pin 42 engages with the pin engagement portion 44 of the lock bar 41, the fixed mold 11 and the intermediate mold 13 are connected.

FIG. 4B illustrates a state in which the movable pin 42 is moved to a position (hereinafter also referred to as a “disconnection position”) at which the movable pin 42 is disconnected from the lock bar 41. When the movable pin 42 is moved to the disconnection position, since the movable pin 42 disengages from the pin engagement portion 44 of the lock bar 41, the fixed mold 11 and the intermediate mold 13 are disconnected from each other. The movable pin 42 having moved to the disconnection position does not interfere with the pin engagement portion 44 even when the lock bar 41 moves in the X-direction with movement of the intermediate mold 13.

The fixing pin 43 is a member fixed to the intermediate mold 13 and fixes the supporting portion 45 of the lock bar 41.

The supporting portion 45 of the lock bar 41 is fixed by the fixing pin 43 so as not to rotate. Therefore, even when the intermediate mold 13 moves in the X-direction, the lock bar 41 does not rotate about the fixing pin 43 but remains approximately parallel to the X-direction as illustrated in FIG. 4B.

The first mold connector 40 of the first embodiment includes the solenoid 46 (see FIG. 2) as a power source for moving the movable pin 42 in the Y (Y1-Y2) direction. When a current is supplied to the solenoid 46 to attract a plunger (not illustrated), the movable pin 42 can be moved to a disconnection position. When the supply of a current to the solenoid 46 is stopped to push the plunger to an original position, the movable pin 42 can be moved to a connection position. In this case, the current supplied from the mold connection control unit 62 to the solenoid 46 serves as a disconnection signal supplied from the mold connection control unit 62 to the first mold connector 40. A state (for example, a zero-ampere state) in which a current is not supplied from the mold connection control unit 62 to the solenoid 46 serves as a connection signal supplied from the mold connection control unit 62 to the first mold connector 40.

As illustrated in FIG. 4A, the second mold connector 50 includes a lock bar 51, a movable pin 52, and a supporting pin 53. The lock bar 51 is a member that connects or disconnects the movable mold 12 and the intermediate mold 13 to or from each other. The lock bar 51 includes a pin engagement portion 54 and a supporting portion 55. The pin engagement portion 54 is a portion formed in an approximately T-form. The supporting portion 55 has a narrow and long hole 55a that can engage with the supporting pin 53.

In the second mold connector 50, since a configuration that drives the movable pin 52 is substantially the same as a configuration that drives the movable pin 42 of the first mold connector 40, the description thereof will be omitted. The supporting pin 53 is a member fixed to the intermediate mold 13. The supporting pin 53 engages with the supporting portion 55 (the long hole 55a) of the lock bar 51. As illustrated in FIG. 4A, the supporting pin 53 has an approximately elliptical shape that is narrow in the X-direction. Therefore, the lock bar 51 does not rotate about the supporting pin 53. As illustrated in FIG. 4A, the lock bar 51 can move in the X-direction by the same distance as an interval d1 formed between the supporting portion 55 and the supporting pin 53. As will be described later, when the movable mold 12 moves in the X1-direction, the same gap s1 as the interval d1 is formed between the movable mold 12 and the intermediate mold 13.

As illustrated in FIG. 4A, a link mechanism 70 is provided between the fixed mold 11 and the fixed-side attachment plate 14. The link mechanism 70 is a mechanism for adjusting a mold opening amount between the fixed mold 11 and the fixed-side attachment plate 14. The link mechanism 70 includes a supporting pin 71, a fixing pin 72, and an engagement plate 73. The supporting pin 71 is a member fixed to the fixed mold 11.

The fixing pin 72 is a member fixed to the fixed-side attachment plate 14. The engagement plate 73 is a planar member and has a narrow and long hole 73a formed therein.

The long hole 73a of the engagement plate 73 engages with the supporting pin 71. An X2-side end of the engagement plate 73 is fixed to the fixing pin 72. Therefore, the fixed mold 11 can move in the X-direction by a distance corresponding to an interval d2 in relation to the fixed-side attachment plate 14.

As will be described later, when the fixed mold 11 moves in the X1-direction, the same gap s2 as the interval d2 is formed between the fixed mold 11 and the fixed-side attachment plate 14. A plurality of link mechanisms 70 is formed between the fixed mold 11 and the fixed-side attachment plate 14. The link mechanism 70 is not limited to the above-described configuration, but a loosened chain may be stretched between the fixed mold 11 and the fixed-side attachment plate 14, for example.

As illustrated in FIG. 4A, in a state in which the first mold connector 40 and the second mold connector 50 connect the corresponding two molds, when a disconnection signal is transmitted from the mold connection control unit 62 (see FIG. 2) to the first mold connector 40, the two movable pins 42 move to disconnection positions in the Y1 and Y2 directions, respectively. When the movable mold 12 is moved in the X1-direction in this state, first, the supporting portion 55 of the lock bar 51 (the second mold connector 50) moves in the X1-direction by the same distance as the interval d1 in relation to the supporting pin 53. Therefore, as illustrated in FIG. 4B, the gap s1 having the same length as the interval d1 is formed in a mating surface (a parting surface) between the movable mold 12 and the intermediate mold 13. When the gap s1 is formed, the molded product (not illustrated) molded between the movable mold 12 and the intermediate mold 13 and the runner molded inside the intermediate mold 13 are separated from the parting surface simultaneously with the mold opening.

After that, as illustrated in FIG. 4B, the intermediate mold 13 moves in the X1-direction together with the movable mold 12. Therefore, a wide gap s3 is formed between the intermediate mold 13 and the fixed mold 11. Since such a wide gap s3 is formed in the mold 10 of the first embodiment, it is possible to take out the runner (not illustrated) molded inside the intermediate mold 13 easily.

When the intermediate mold 13 moves in the X1-direction together with the movable mold 12, since the fixed mold 11 moves while being caught by the runner remaining in the intermediate mold 13, the supporting pin 71 of the link mechanism 70 moves in the X1-direction by the distance corresponding to the interval d2 in relation to the engagement plate 73 (the details will be described later). Therefore, as illustrated in FIG. 4B, the gap s2 having the same length as the interval d2 is formed in the mating surface (a parting surface) between the fixed mold 11 and the fixed-side attachment plate 14. When the gap s2 is formed, the runner molded between the fixed mold 11 and the fixed-side attachment plate 14 is separated from the parting surface simultaneously with the mold opening. An operation when the movable mold 12 solely moves in the X1-direction will be described later.

Next, an operation of the mold 10 in the injection molding machine 1 of the first embodiment will be described with reference to FIGS. 5A to 5G. FIGS. 5A to 5G are schematic diagrams illustrating a state in which the fixed mold 11, the movable mold 12, and the intermediate mold 13 that form the mold 10 move in one cycle of molding. One cycle of molding refers to a series of steps including a step of closing the mold 10, an injection step, a mold opening step, a molded product take-out step, and a mold closing step. In FIGS. 5A to 5G to be described later, only portions required for description of operations of the injection molding machine 1 will be illustrated.

FIG. 5A is a schematic diagram illustrating the closed mold 10. As illustrated in FIG. 5A, the closed mold 10 before one cycle starts is in a state in which the gap between the fixed mold 11 and the fixed-side attachment plate 14, the gap between the fixed mold 11 and the intermediate mold 13, and the gap between the movable mold 12 and the intermediate mold 13 are closed. Although not illustrated in the drawings, the fixed mold 11 and the intermediate mold 13 of the closed mold 10 are connected by the first mold connector 40 (see FIG. 4A). Moreover, the movable mold 12 and the intermediate mold 13 are connected by the second mold connector 50 (see FIG. 4A). In the closed mold 10, the first mold connector 40 and the second mold connector 50 may be connected as described above or may be disconnected.

FIG. 5B is a schematic diagram illustrating an injection step. As illustrated in FIG. 5B, in the injection step, a molding material is filled into the closed mold 10 from the injection device 30. After that, a subsequent first mold opening step is performed through packing, plasticating, cooling, and the like.

FIGS. 5C and 5D are schematic diagrams illustrating the first mold opening step. In the first mold opening step, the movable mold 12 is moved in the X1-direction so that the movable mold 12 is separated from the fixed mold 11 together with the intermediate mold 13. In the first mold opening step, a connection state of the first mold connector 40 (see FIG. 4B) is switched, and the intermediate mold 13 and the fixed mold 11 are disconnected. In this state, since switching of the connection state of the second mold connector 50 is not performed, the movable mold 12 and the intermediate mold 13 remain in the connection state. After such switching of the connection state is performed, when the movable mold 12 starts moving in the X1-direction, as illustrated in FIG. 5C, the gap s1 is formed on a mating surface P1 between the movable mold 12 and the intermediate mold 13. When the gap s1 is formed, the molded product 2 and the runner 3 are separated.

Although not illustrated in the drawings, a lock mechanism such as a plastic lock, a magnet lock, or a mechanical lock, for example, can be used as a mechanism for controlling the procedure of opening the mold 10. By using these lock mechanisms, it is possible to separate the mating surface P1 between the movable mold 12 and the intermediate mold 13 for the first time and subsequently to separate the intermediate mold 13 and the fixed mold 11 from each other.

When the movable mold 12 moves in the X1-direction, the runner 3 is drawn from the intermediate mold 13. When the runner 3 is drawn from the intermediate mold 13, since frictional resistance occurs between the fixed mold 11 and the runner 3, the fixed mold 11 is moved by the distance corresponding to the interval d2 (see FIG. 4A) in the X1-direction while being caught by the runner 3. When the fixed mold 11 moves by the distance corresponding to the interval d2 in the X1-direction, the gap s2 is formed on the mating surface P2 between the fixed mold 11 and the fixed-side attachment plate 14. When the gap s2 is formed, the X2-side portion of the runner 3 is separated from the fixed-side attachment plate 14. As illustrated in FIG. 5D, when the movable mold 12 moves in the X1-direction to reach a mold opening position, the mold 10 enters into a first mold opening state. When the movable mold 12 reaches the mold opening position, the wide gap s3 is formed between the intermediate mold 13 and the fixed mold 11.

FIG. 5E is a schematic diagram illustrating a runner take-out step. As illustrated in FIG. 5E, in the runner take-out step, the runner 3 is taken out from the open mold 10 by a robot arm 80. In the runner take-out step, since the wide gap s3 is formed between the fixed mold 11 and the intermediate mold 13, the runner 3 can be easily taken out from the space between the fixed mold 11 and the intermediate mold 13.

FIG. 5F is a schematic diagram illustrating a mold closing step. In the mold closing step, as illustrated in FIG. 5F, the movable mold 12 is moved in the direction (X2-direction) toward the fixed mold 11. In the mold closing step, the intermediate mold 13 is moved by the movable mold 12 to a position at which the intermediate mold 13 makes contact with the fixed mold 11. In the mold closing step, the reason why the intermediate mold 13 is moved to a position at which the intermediate mold 13 makes contact with the fixed mold 11 is to form a wide gap s4 between the movable mold 12 and the intermediate mold 13 in a second mold opening step to be described later. When the intermediate mold 13 is moved to a position at which the intermediate mold 13 makes contact with the fixed mold 11, the fixed mold 11 and the intermediate mold 13 are connected by the first mold connector 40 (see FIG. 4A). Moreover, the movable mold 12 and the intermediate mold 13 are disconnected by the second mold connector 50 (see FIG. 4A). When the movable mold 12 is disconnected from the intermediate mold 13, the movable mold 12 moves independently in the second mold opening step to be described later.

In the mold closing step, either one of the fixed mold 11, the intermediate mold 13, and the movable mold 12 may not be closed. That is, in the second mold opening step to be described later, if the intermediate mold 13 is not pulled by the movable mold 12 moving in the X1-direction, the fixed mold 11 and the intermediate mold 13 may not be connected by the first mold connector 40. If the movable mold 12 and the intermediate mold 13 can be disconnected by the second mold connector 50 when the intermediate mold 13 is moved to a position at which the intermediate mold 13 makes contact with the fixed mold 11 with the movement of the movable mold 12, the movable mold 12 may not make contact with the intermediate mold 13.

FIG. 5G is a schematic diagram illustrating a second mold opening step and a molded product take-out step. In the second mold opening step, the movable mold 12 is moved in the X1-direction so that the movable mold 12 is separated from the intermediate mold 13 and the fixed mold 11. As illustrated in FIG. 5G, when the movable mold 12 moves in the X1-direction to reach the mold opening position, the mold 10 enters into a second mold opening state. When the movable mold 12 reaches the mold opening position, a wide gap s4 is formed between the movable mold 12 and the intermediate mold 13. In the second mold opening state, similarly to the first mold opening state, since the gap s1 and the gap s2 (see FIGS. 5C and 5D) are not formed between the molds, the gap s4 wider than the gap s3 in the first mold opening state is formed.

Subsequently, in the molded product take-out step, the molded product 2 is taken out of the open mold 10 by the robot arm 80. In the molded product take-out step, since the wide gap s4 (>s3) is formed between the fixed mold 11 and the intermediate mold 13, the molded product 2 can be easily taken out from the inside of the movable mold 12.

After the molded product take-out step is performed, the space between the fixed mold 11 and the fixed-side attachment plate 14, the space between the fixed mold 11 and the intermediate mold 13, and the space between the movable mold 12 and the intermediate mold 13 are closed, and the mold 10 enters into a mold closing state as illustrated in FIG. 5A. In this way, one cycle of molding is completed.

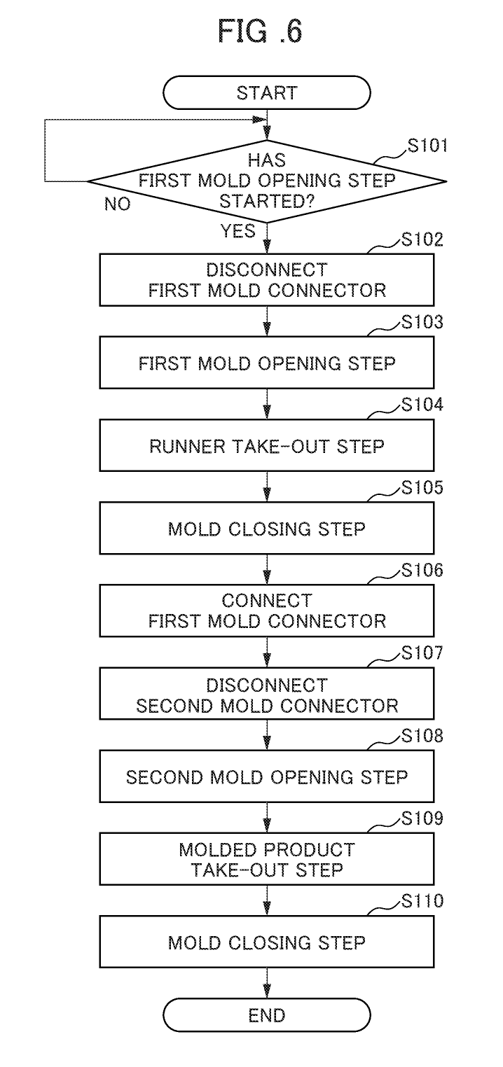

Next, the details of the processing of the mold moving and connecting control program executed by the injection molding machine 1 (the controller 60) of the first embodiment will be described on the basis of the flowchart illustrated in FIG. 6.

FIG. 6 is a flowchart illustrating a processing procedure of the mold moving and connecting control program executed by the controller 60 of the first embodiment.

In step S101 illustrated in FIG. 6, the controller main body (the controller 60) determines whether the first mold opening step of the mold 10 has started. For example, the first mold opening step starts when packing, plasticating, cooling, and the like are completed after the injection step illustrated in FIG. 5B. When the controller main body determines in step S101 that opening of the mold 10 has started, the flow proceeds to step S102. When the controller main body determines that opening of the mold 10 has not started, the flow proceeds (returns) to step S101.

In step S102 (step S101: YES), the mold connection control unit 62 (the controller 60) transmits a disconnection signal to the first mold connector 40 so that the fixed mold 11 and the intermediate mold 13 are disconnected.

In step S103, the mold movement control unit 61 moves the movable mold 12 in a direction (the X1-direction) away from the fixed mold 11. In this case, since the intermediate mold 13 is connected to the movable mold 12 by the second mold connector 50, the intermediate mold 13 moves together with the movable mold 12. When the movable mold 12 reaches the mold opening position and the mold 10 enters into the first mold opening state, the wide gap s3 is formed between the intermediate mold 13 and the fixed mold 11 as illustrated in FIG. 5D, for example, (the first mold opening step).

In step S104, the controller main body controls the robot arm 80 to take out the runner 3 from the space between the fixed mold 11 and the intermediate mold 13 as illustrated in FIG. 5E, for example (the runner take-out step).

In step S105, the mold movement control unit 61 moves the movable mold 12 in the direction (the X2-direction) toward the fixed mold 11. In this case, the intermediate mold 13 moves in the X2-direction so as to be pressed by the movable mold 12. When the movable mold 12 reaches a mold closing position, the mold 10 enters into a mold closing state as illustrated in FIG. 5C, for example (the mold closing step).

In step S106, the mold connection control unit 62 transmits a connection signal to the first mold connector 40 so that the fixed mold 11 and the intermediate mold 13 are connected. In step S107, the mold connection control unit 62 transmits a disconnection signal to the second mold connector 50 so that the movable mold 12 and the intermediate mold 13 are disconnected. The order of the processes of steps S106 and S107 may be reversed and may be executed simultaneously.

In step S108, the mold movement control unit 61 moves the movable mold 12 in the direction (the X1-direction) away from the fixed mold 11. When the movable mold 12 reaches the mold opening position so and the mold 10 enters into the second mold opening state, the wide gap s4 is formed between the movable mold 12 and the intermediate mold 13 as illustrated in FIG. 5G, for example (the second mold opening step).

In step S109, the controller main body controls the robot arm 80 as illustrated in FIG. 5G, for example, to take out the molded product 2 from the space between the movable mold 12 and the intermediate mold 13 (the molded product take-out step).

In step S110, the mold movement control unit 61 moves the movable mold 12 in the direction (the X2-direction) toward the fixed mold 11. In this case, the intermediate mold 13 moves in the X2-direction so as to be pressed by the movable mold 12.

When the movable mold 12 reaches the mold closing position, the mold 10 enters into such a mold closing state as illustrated in FIG. 5A, for example (the mold closing step). After step S110, the process of this flowchart ends. After step S110, the injection step illustrated in FIG. 5B starts, for example.

According to the injection molding machine 1 of the first embodiment, the following advantages, for example, are obtained. The advantages of the injection molding machine 1 of the first embodiment are common to the second and third embodiments to be described later. According to the injection molding machine 1 of the first embodiment, in the first mold opening state, since the wide gap s3 is formed between the intermediate mold 13 and the fixed mold 11 as illustrated in FIG. 5D, it becomes easy to take out the runner 3. In the second mold opening state, as illustrated in FIG. 5G, since the wide gap s4 is formed between the movable mold 12 and the intermediate mold 13 as illustrated in FIG. 5G, it becomes easy to take out the molded product 2. In the injection molding machine 1 of the first embodiment, it becomes easy to take out the molded product 2 and the runner 3 when performing molding using the mold 10 which is a three-plate mold.

In the injection molding machine 1 of the first embodiment, the intermediate mold 13 is moved alternately in the X1-direction and the X2-direction whereby the wide gap s3 is formed between the intermediate mold 13 and the fixed mold 11 in the first mold opening state, and the wide gap s4 (>s3) is formed between the movable mold 12 and the intermediate mold 13 in the second mold opening state. Therefore, the mold opening amount of the mold 10 can be decreased as compared to a system in which the fixed mold and the movable mold are moved away from each other with the intermediate mold sandwiched therebetween as a conventional three-plate mold. Therefore, according to the injection molding machine 1 of the first embodiment, it is possible to easily take out the molded product 2 and the runner 3 and to further decrease the size of the mold 10.

A molding method of inserting a component in the mold 10 and then performing a mold closing operation after taking out the molded product 2 from the movable mold 12 may be used. In such a molding method, when the molded product 2 is taken out, the robot arm 80 may grasp the molded product 2 and the inserted component. In the injection molding machine 1 of the first embodiment, since the wide gap s4 is formed between the movable mold 12 and the intermediate mold 13 in the second mold opening state of taking out the molded product 2, it is possible to secure a sufficient space for the robot arm 80 to perform operations without increasing an overall mold opening amount of the mold 10.

In the injection molding machine 1 of the present embodiment, the first mold connector 40 and the second mold connector 50 are driven with a connection signal or a disconnection signal transmitted from the mold connection control unit 62. Therefore, it is possible to switch the connection state of the fixed mold 11 and the intermediate mold 13 and the connection state of the movable mold 12 and the intermediate mold 13 more quickly.

### Second Embodiment

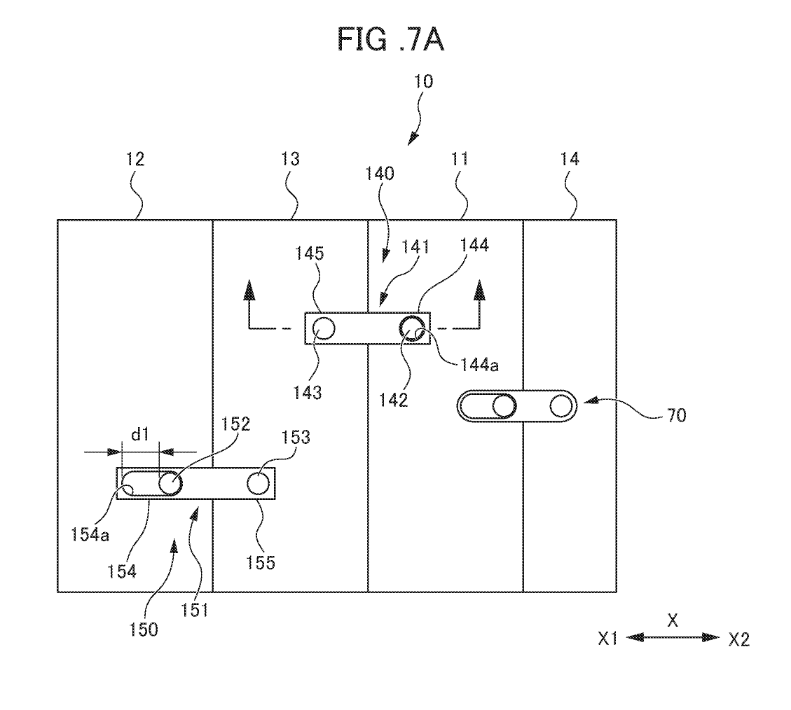

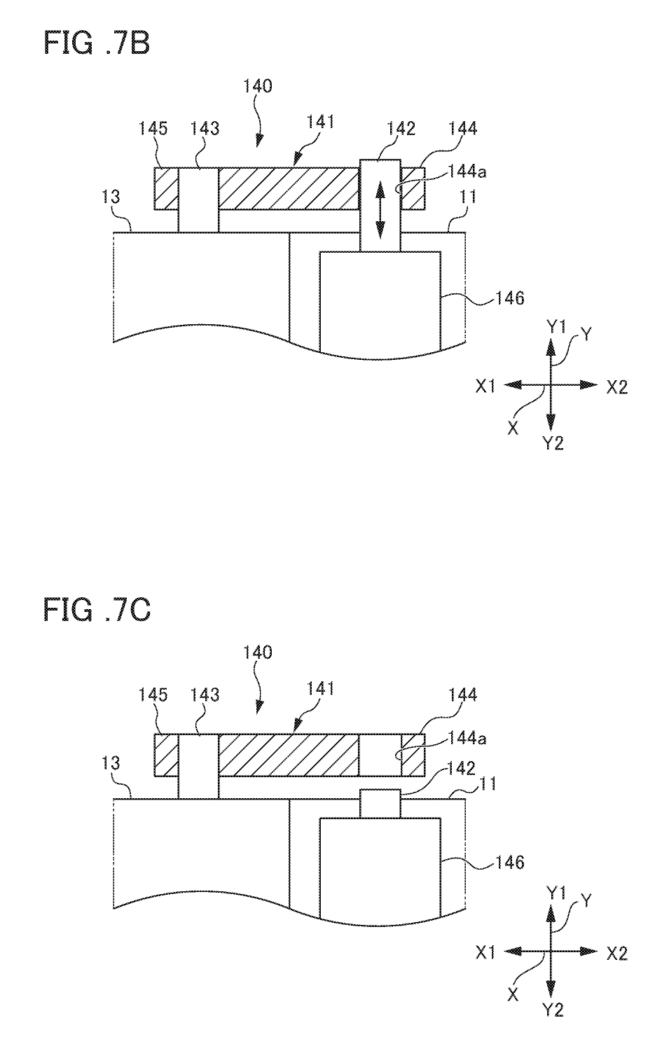

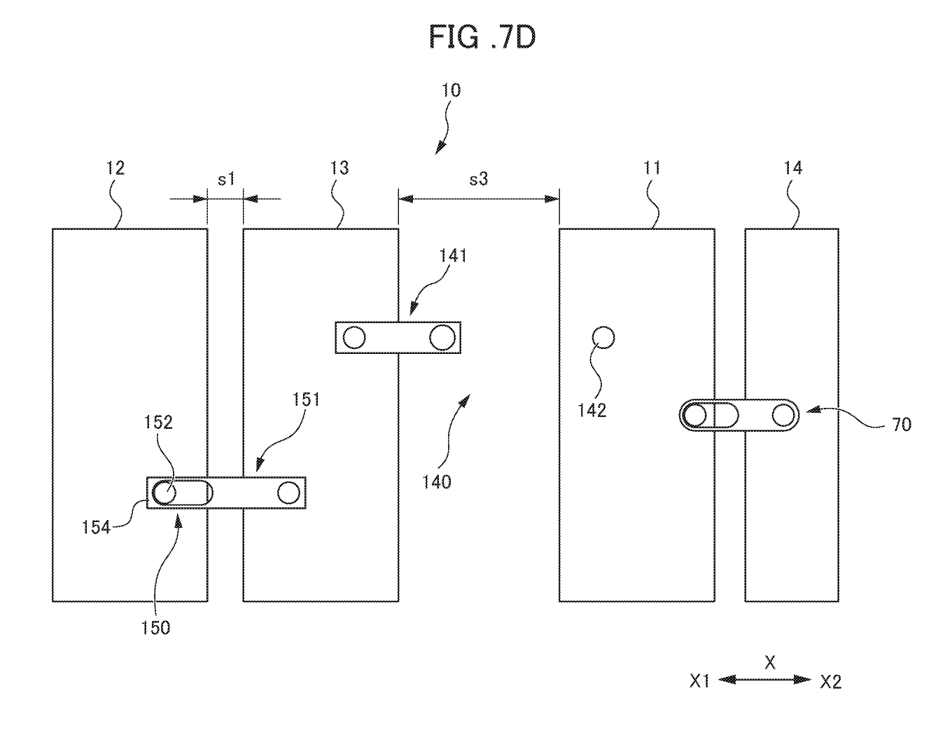

FIG. 7A to 7D are schematic diagrams illustrating a first mold connector 140 and a second mold connector 150 according to the second embodiment. FIG. 7A is a schematic diagram illustrating a state in which the first mold connector 140 and the second mold connector 150 of the second embodiment are connected. FIGS. 7B and 7C are cross-sectional views along line A-A in FIG. 7A. FIG. 7D is a schematic diagram illustrating a state in which the first mold connector 140 of the second embodiment is disconnected. In the description and the drawings of the second embodiment, portions that perform the same functions as the constituent elements of the first embodiment will be appropriately denoted by the same reference numerals or the same ending reference numerals (the last two digits), and the redundant description thereof will be omitted appropriately.

As illustrated in FIG. 7A, the first mold connector 140 of the second embodiment includes a lock bar 141, a movable pin 142, and a fixing pin 143. The lock bar 141 is a member that connects or disconnects the fixed mold 11 and the intermediate mold 13 to or from each other. The lock bar 141 includes a pin engagement portion 144 and a supporting portion 145. The pin engagement portion 144 has a hole 144a with which the movable pin 142 can engage. The supporting portion 145 is a portion fixed to the fixing pin 143.

The movable pin 142 is a member movable in the Y (Y1-Y2) direction as illustrated in FIG. 7B. FIG. 7B illustrates a state in which the movable pin 142 has moved to a connection position at which the movable pin 142 is connected to the lock bar 141. As illustrated in FIG. 7B, when the movable pin 142 moves to the connection position, since the movable pin 142 engages with the pin engagement portion 144 of the lock bar 141, the fixed mold 11 and the intermediate mold 13 enter into a connection state.

FIG. 7C illustrates a state in which the movable pin 142 has moved to a disconnection position at which the movable pin 142 is disconnected from the lock bar 141. As illustrated in FIG. 7C, when the movable pin 142 moves to the disconnection position, since the movable pin 142 is disengaged from the pin engagement portion 144 of the lock bar 141, the fixed mold 11 and the intermediate mold 13 enter into a disconnection state.

The fixing pin 143 is a member fixed to the intermediate mold 13 and fixes the supporting portion 145 of the lock bar 141. The supporting portion 145 of the lock bar 141 is fixed by the fixing pin 143 so as not to rotate. Therefore, even when the intermediate mold 13 moves in the X-direction, the lock bar 141 does not rotate about the fixing pin 143 and remains approximately parallel to the X-direction as illustrated in FIG. 7B.

The first mold connector 140 of the second embodiment includes a solenoid 146 (see FIG. 7B) as a power source for moving the movable pin 142 in the Y-direction. When a current is supplied to the solenoid 146 to attract a plunger (not illustrated), the movable pin 142 can be moved to a disconnection position. When the supply of a current to the solenoid 146 is stopped to push the plunger to an original position, the movable pin 142 can be moved to a connection position. In this case, the current supplied from the mold connection control unit 62 to the solenoid 146 serves as a disconnection signal supplied from the mold connection control unit 62 to the first mold connector 140. A state (for example, a zero-ampere state) in which a current is not supplied from the mold connection control unit 62 to the solenoid 146 serves as a connection signal supplied from the mold connection control unit 62 to the first mold connector 140.

As illustrated in FIG. 7A, the second mold connector 150 of the second embodiment includes a lock bar 151, a movable pin 152, and a fixing pin 153. The lock bar 151 is a member that connects or disconnects the movable mold 12 and the intermediate mold 13 to or from each other. The lock bar 151 includes a pin engagement portion 154 and a supporting portion 155. The pin engagement portion 154 has a narrow and long hole 154a that can engage with the movable pin 152. The supporting portion 155 is a portion fixed to the fixing pin 153.

In the second mold connector 150, since a configuration that drives the movable pin 152 is substantially the same as a configuration (the solenoid 146) that drives the movable pin 142 of the first mold connector 140, the description thereof will be omitted. The movable pin 152 is provided in the movable mold 12. The movable pin 152 engages with the pin engagement portion 154 of the lock bar 151. As illustrated in FIG. 7A, the movable pin 152 has an approximately elliptical shape that is narrow in the X-direction. When the pin engagement portion 154 of the lock bar 151 engages with the movable pin 152, the lock bar 151 can move by the same distance as the interval d1 formed between the pin engagement portion 154 and the movable pin 152. As will be described later, when the movable mold 12 moves in the X1-direction, the same gap s1 as the interval d1 is formed between the movable mold 12 and the intermediate mold 13.

The fixing pin 153 is a member fixed to the intermediate mold 13 and fixes the supporting portion 155 of the lock bar 151. The supporting portion 155 of the lock bar 151 is fixed by the fixing pin 153 so as not to rotate. Therefore, even when the intermediate mold 13 moves in the X-direction, the lock bar 151 does not rotate about the fixing pin 153 and remains approximately parallel to the X-direction as illustrated in FIG. 7D.

As illustrated in FIG. 7A, in a state in which the first mold connector 140 and the second mold connector 150 connect the corresponding two molds, when a disconnection signal is transmitted from the mold connection control unit 62 (see FIG. 2) to the first mold connector 140, the movable pin 142 moves to disconnection position in the Y2-direction. When the movable mold 12 is moved in the X1-direction in this state, as illustrated in FIG. 7D, the intermediate mold 13 connected to the movable mold 12 moves in the X1-direction together with the movable mold 12. Therefore, the wide gap s3 is formed between the intermediate mold 13 and the fixed mold 11.

When the movable mold 12 moves in the X1-direction, as illustrated in FIG. 7D, the movable pin 152 moves in the X1-direction by the same distance as the interval d1 in relation to the pin engagement portion 154 of the lock bar 151 (the second mold connector 150). Therefore, the gap s1 having the same length as the interval d1 is formed in the mating surface (a parting surface) between the movable mold 12 and the intermediate mold 13. When the gap s1 is formed, the molded product (not illustrated) molded between the movable mold 12 and the intermediate mold 13 and the runner molded inside the intermediate mold 13 can be separated from the parting surface simultaneously with the mold opening.

### Third Embodiment

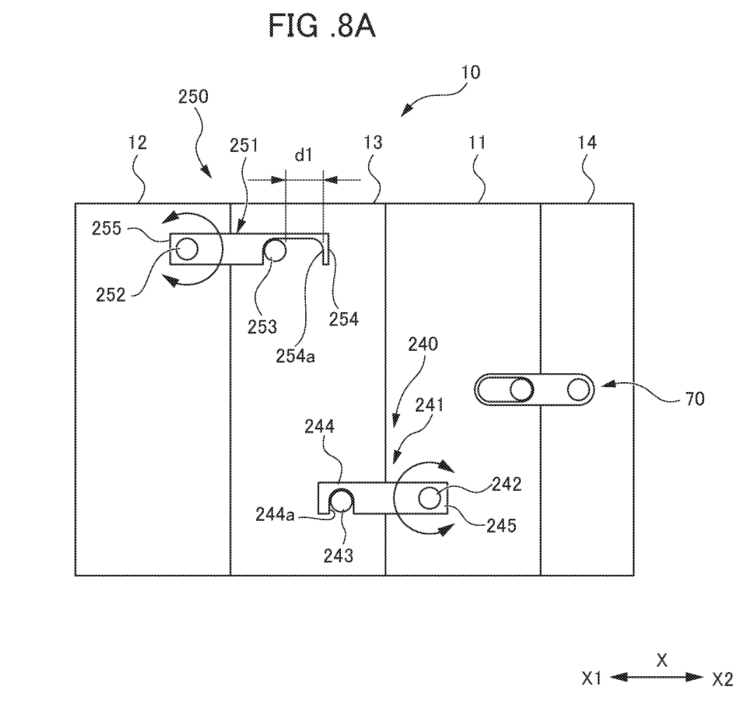

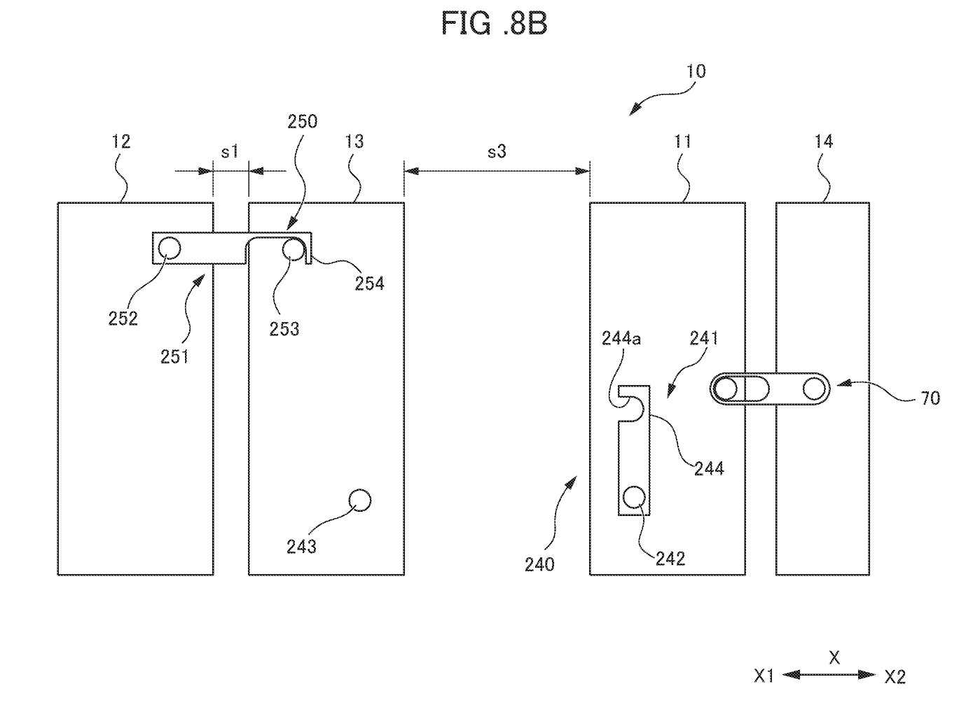

FIGS. 8A and 8B are schematic diagrams illustrating a first mold connector 240 and a second mold connector 250 according to the third embodiment. FIG. 8A is a schematic diagram illustrating a state in which the first mold connector 240 and the second mold connector 250 of the third embodiment are connected. FIG. 8B is a schematic diagram illustrating a state in which the first mold connector 240 of the third embodiment is disconnected. In the description and the drawings of the third embodiment, portions that perform the same functions as the constituent elements of the first embodiment will be appropriately denoted by the same reference numerals or the same ending reference numerals (the last two digits), and the redundant description thereof will be omitted appropriately.

As illustrated in FIG. 8A, the first mold connector 240 of the third embodiment includes a lock bar 241, a movable pin 242, and a fixing pin 243. The lock bar 241 is a member that connects or disconnects the fixed mold 11 and the intermediate mold 13 to or from each other. The lock bar 241 includes a pin engagement portion 244 and a supporting portion 245.

The pin engagement portion 244 has a recess-shaped depression 244a formed on a side facing the fixing pin 243. The depression 244a is a portion that engages with the fixing pin 243. The supporting portion 245 is a portion fixed to the movable pin 242. The supporting portion 245 of the lock bar 241 rotates with the movable pin 242. Therefore, the lock bar 242 rotates clockwise and counter-clockwise directions about the movable pin 242 as indicated by arrows in the drawing.

The movable pin 242 is a member that rotates clockwise and counter-clockwise directions. FIG. 8A illustrates a state in which the movable pin 242 has rotated to the connection position. When the movable pin 242 rotates to the connection position in the counter-clockwise direction, since the pin engagement portion 244 (the depression 244a) of the lock bar 241 engages with the fixing pin 243, the fixed mold 11 and the intermediate mold 13 enter into a connection state. FIG. 8B illustrates a state in which the movable pin 242 has rotated to a disconnection position. When the movable pin 242 rotates to the disconnection position in the clockwise direction, since the pin engagement portion 244 (the depression 244a) of the lock bar 241 disengages from the fixing pin 243, the fixed mold 11 and the intermediate mold 13 enter into a disconnection state. The fixing pin 243 is a member fixed to the intermediate mold 13. The fixing pin 243 engages with the pin engagement portion 244 (the depression 244a) of the lock bar 241.

A servo motor (not illustrated), for example, can be used as a power source for rotating the movable pin 242 in the clockwise and counter-clockwise directions. By supplying a normal rotation pulse signal to the servo motor, it is possible to rotate the movable pin 242 in the clockwise direction, for example. By supplying a reverse rotation pulse signal to the servo motor, it is possible to rotate the movable pin 242 in the counter-clockwise direction. In this case, the normal rotation pulse signal supplied from the mold connection control unit 62 to the servo motor serves as a disconnection signal supplied from the mold connection control unit 62 to the first mold connector 40. The reverse rotation pulse signal supplied from the mold connection control unit 62 to the servo motor serves as a connection signal supplied from the mold connection control unit 62 to the first mold connector 40.

As illustrated in FIG. 8A, the second mold connector 250 of the third embodiment includes a lock bar 251, a movable pin 252, and a fixing pin 253. The lock bar 251 is a member that connects or disconnects the movable mold 12 and the intermediate mold 13 to or from each other. The lock bar 251 includes a pin engagement portion 254 and a supporting portion 255. The pin engagement portion 254 is a portion that engages with the fixing pin 253. The pin engagement portion 254 has a narrow and long recess-shaped depression 254a that engages with the fixing pin 253.

When the pin engagement portion 254 (the depression 254a) of the lock bar 251 engages with the fixing pin 253, the lock bar 251 can move in the X-direction by the same distance as the interval d1 formed between the pin engagement portion 254 and the fixing pin 253. When the movable mold 12 moves in the X1-direction in a state in which the pin engagement portion 254 of the lock bar 251 engages with the fixing pin 253, the same gap s1 as the interval d1 is formed between the movable mold 12 and the intermediate mold 13 as will be described later.

The supporting portion 255 of the lock bar 251 is a portion fixed to the movable pin 252. Since a configuration for driving the movable pin 252 is the same as a configuration (for example, a servo motor) for driving the movable pin 242 of the first mold connector 240, the description thereof will be omitted.

As illustrated in FIG. 8A, in a state in which the first mold connector 240 and the second mold connector 250 connect the corresponding two molds, when a disconnection signal is transmitted from the mold connection control unit 62 (see FIG. 2) to the first mold connector 240, the lock bar 241 rotates about the movable pin 242 in the clockwise direction. Therefore, the fixed mold 11 and the intermediate mold 13 enter into a disconnection state. When the movable mold 12 is moved in the X1-direction in this state, as illustrated in FIG. 8B, the intermediate mold 13 connected to the movable mold 12 moves in the X1-direction together with the movable mold 12. Therefore, the wide gap s3 is formed between the intermediate mold 13 and the fixed mold 11.

When the movable mold 12 moves in the X1-direction, the pin engagement portion 254 of the lock bar 251 (the second mold connector 250) moves in the X1-direction by the same distance as the interval d1 in relation to the fixing pin 253.

Therefore, the gap s1 having the same length as the interval d1 is formed in the mating surface (a parting surface) between the movable mold 12 and the intermediate mold 13. When the gap s1 is formed, the molded product (not illustrated) molded between the movable mold 12 and the intermediate mold 13 and the runner molded inside the intermediate mold 13 can be separated from the parting surface simultaneously with the mold opening.

While the embodiments of the present invention have been described, the present invention is not limited to the above-described embodiments. Various modifications and changes can be made like modifications to be described later, and these embodiments also fall within the technical scope of the present invention. The advantages described in the embodiments are only examples of most preferable effects produced by the present invention, and the advantages of the present invention are not limited to those described in the embodiments. The above-described embodiments and the modifications to be described later can be appropriately used in combination, and the detailed description thereof will be omitted.

### Modification

In the first mold connector 40 (see FIGS. 4A and 4B) of the first embodiment, the orientation in the X-direction of the lock bar 41 may be reversed so that the movable pin 42 is provided in the intermediate mold 13 and the fixing pin 43 is provided in the fixed mold 11. In the second mold connector 50 (see FIGS. 4A and 4B) of the first embodiment, the orientation in the X-direction of the lock bar 51 may be reversed so that the movable pin 52 is provided in the intermediate mold 13 and the supporting pin 53 is provided in the movable mold 12.

In the first mold connector 140 (see FIG. 7A) of the second embodiment, the orientation in the X-direction of the lock bar 141 may be reversed so that the movable pin 142 is provided in the intermediate mold 13 and the fixing pin 143 is provided in the fixed mold 11. In the second mold connector 150 (see FIG. 7A) of the second embodiment, the orientation in the X-direction of the lock bar 151 may be reversed so that the movable pin 152 is provided in the intermediate mold 13 and the fixing pin 153 is provided in the movable mold 12.

In the first mold connector 240 (see FIG. 8A) of the third embodiment, the orientation in the X-direction of the lock bar 241 may be reversed so that the movable pin 242 is provided in the intermediate mold 13 and the fixing pin 243 is provided in the fixed mold 11. In the second mold connector 250 (see FIG. 8A) of the third embodiment, the orientation in the X-direction of the lock bar 251 may be reversed so that the movable pin 252 is provided in the intermediate mold 13 and the fixing pin 253 is provided in the movable mold 12.

The first and second mold connectors of the first to third embodiments may be used in combination and may be used together with other connection mechanisms. The mold connector of the present invention is not limited to the configuration of the first to third embodiments but an arbitrary configuration may be used as long as it is possible to switch the connection state between the fixed mold 11 and the intermediate mold 13 and the connection state between the movable mold 12 and the intermediate mold 13.

In the first to third embodiments, although an example in which the runner 3 is taken out in the first mold opening state and the molded product 2 is taken out in the second mold opening state has been described, the molded product 2 may be taken out in the first mold opening state and the runner 3 may be taken out in the second mold opening state. Specifically, in the first mold opening step illustrated in FIGS. 5C and 5D, the movable mold 12 only is moved in the X1-direction to form a gap between the movable mold 12 and the intermediate mold 13 to take out the molded product 2. Subsequently, the movable mold 12 is moved in the direction (the X2-direction) toward the fixed mold 11 to be connected to the intermediate mold 13. Subsequently, the movable mold 12 is moved in the X1-direction together with the intermediate mold 13 to form a gap between the intermediate mold 13 and the fixed mold 11 to take out the runner 3.

In the first to third embodiments, although an example in which the intermediate mold 13 and the movable mold 12 are connected in the first mold opening state and the intermediate mold 13 and the fixed mold 11 are connected in the second mold opening state has been described, there is not limitation thereto. In one cycle of molding, the intermediate mold 13 may be used in a state of being not connected to either one of the movable mold 12 and the fixed mold 11.

### EXPLANATION OF REFERENCE NUMERALS

1: Injection molding machine
10: Mold
11: Fixed mold
12: Movable mold
13: Intermediate mold
20: Mold moving device
30: Injection device
40, 140, 240: First mold connector
50, 150, 250: Second mold connector
60: Controller
61: Mold movement control unit
62: Mold connection control unit
70: Link mechanism

What is claimed is:

1. An injection molding machine including a three-plate-type mold including a fixed mold, a movable mold that is movable in relation to the fixed mold, and an intermediate mold provided between the fixed mold and the movable mold, the injection molding machine filling a molding material in a cavity formed by closing the fixed mold, the movable mold, and the intermediate mold to mold a molded product, the injection molding machine comprising:
a first mold connector that connects or disconnects the fixed mold and the intermediate mold to or from each other;
a second mold connector that connects or disconnects the movable mold and the intermediate mold to or from each other;
a mold moving device that moves the movable mold in relation to the fixed mold;
a mold movement control unit that controls the mold moving device so that any one of a mold closing state in which the movable mold, the intermediate mold, and the fixed mold are connected, a first mold opening state in which the movable mold is separated from the fixed mold together with the intermediate mold, and a second mold opening state in which the movable mold is separated from the intermediate mold and the fixed mold is created; and
a mold connection control unit that controls the first mold connector and the second mold connector so that in the first mold opening state, the first mold connector disconnects the fixed mold and the intermediate mold and the second mold connector connects the movable mold and the intermediate mold, and in the second mold opening state, the first mold connector connects the fixed mold and the intermediate mold and the second mold connector disconnects the movable mold and the intermediate mold.

2. The injection molding machine according to claim 1, wherein
the first mold connector and the second mold connector each include:
a movable pin provided in one mold; a fixing pin provided in the other mold; and a lock bar having a supporting portion fixed to the fixing pin and a pin engagement portion configured to engage with the movable pin, and
the movable pin moves to a position at which the movable pin engages with the pin engagement portion of the lock bar so that both molds enter into a connection state, and the movable pin moves to a position at which the movable pin is disengaged from the pin engagement portion of the lock bar so that both molds enter into a disconnection state.

3. The injection molding machine according to claim 1, wherein the first mold connector and the second mold connector each include:
a movable pin provided in one mold; a fixing pin provided in the other mold; and a lock bar having a supporting portion fixed to the movable pin and a pin engagement portion configured to engage with the fixing pin, and
the movable pin rotates and the pin engagement portion of the lock bar engages with the fixing pin so that both molds enter into a connection state, and the movable pin rotates in an opposite direction and the pin engagement portion of the lock bar is disengaged from the fixing pin so that both molds enter into a disconnection state.

4. An injection molding method executed by an injection molding machine including: a three-plate-type mold including a fixed mold, a movable mold that is movable in relation to the fixed mold, and an intermediate mold provided between the fixed mold and the movable mold; a first mold connector that connects or disconnects the fixed mold and the intermediate mold to or from each other; a second mold connector that connects or disconnects the movable mold and the intermediate mold to or from each other; and a mold moving device that moves the movable mold in relation to the fixed mold, wherein
a first mold opening state in which the movable mold is separated from the fixed mold together with the intermediate mold, the first mold connector disconnects the fixed mold and the intermediate mold and the second mold connector connects the movable mold and the intermediate mold, and
a second mold opening state in which the movable mold is separated from the intermediate mold and the fixed mold, the first mold connector connects the fixed mold and the intermediate mold and the second mold connector disconnects the movable mold and the intermediate mold.
